(19) United States
(12) Patent Application Publication
(10) Pub. No.: US 2025/0206009 A1
(43) Pub. Date: Jun. 26, 2025

(54) TRANSFER FILM AND METHOD FOR TRANSFERRING A BARRIER LAYER ONTO A SUBSTRATE

(71) Applicant: Fraunhofer-Gesellschaft zur Foerderung der angewandten Forschung e.V., Muenchen (DE)

(72) Inventors: Marius JESDINSZKI, Freising (DE); Andreas STAEBLER, Freising (DE); Klaus NOLLER, Freising (DE); Daniel SCHLEMMER, Freising (DE)

(73) Assignee: Fraunhofer-Gesellschaft zur Foerderung der angewandten Forschung e.V., Muenchen (DE)

(21) Appl. No.: 18/849,555

(22) PCT Filed: Mar. 7, 2023
(86) PCT No.: PCT/EP2023/055712

§ 371 Date: Sep. 23, 2024

(30) Foreign Application Priority Data
Mar. 24, 2022 (DE) 10 2022 106 962.1

(51) Int. Cl. B32B 37/00; B32B 7/12; B32B 15/082; B32B 15/12; B32B 15/20; B32B 37/24; B32B 38/10

(52) U.S. Cl. CPC B32B 37/025; B32B 7/12; B32B 15/082; B32B 15/12; B32B 15/20; B32B 37/24; B32B 38/10; B32B 2037/246; B32B 2250/03; B32B 2307/7244; B32B 2307/73; B32B 2307/7376; B32B 2311/24; B32B 2329/04

(57) ABSTRACT

The present invention relates to a transfer film for applying a barrier layer onto a substrate. The transfer film comprises a carrier film, on which a layer sequence is applied consisting of at least one lacquer layer, made of a barrier lacquer, and an inorganic layer, wherein the adhesive forces between the lacquer layer and the carrier film are lower than the adhesive forces between the lacquer layer and the inorganic layer. The transfer film is characterized in that the barrier lacquer comprises a polymer matrix having a hydrophilic component and a hydrophobic component, of which the hydrophilic component significantly outweighs the hydrophobic component. The transfer film allows a barrier layer having effective barrier properties to be transferred onto target substrates, for which this was previously technically impossible or economically impractical.

### FIELD OF THE INVENTION

The present invention relates to a composite film, also referred to below as a transfer film, and a method for transferring a barrier layer to another substrate. The composite film comprises a carrier film on which a layer sequence consisting of a lacquer layer made of a barrier lacquer and an inorganic layer, also referred to as metallisation, is applied to the lacquer layer. The composite film is suitable for transferring the barrier properties of the combination of barrier lacquer and inorganic layer with respect to oxygen, water vapour and other organic substances to another substrate, such as paper or cardboard, with the aid of a transfer process.

A technically obvious area in which such a film can be used is, for example, but not exclusively, the area of food packaging.

### PRIOR ART

An important function of food packaging is to protect the packaged goods from environmental influences that promote spoilage, such as oxygen, water vapour or light. In order to ensure this protective function and thus a long shelf life of the food, materials are often used in packaging that have a barrier effect with respect to such environmental influences. Typically, desired permeation for values sensitive foods (e.g., meat, fish) are <5 cm³/(m² d bar) at 23° C. and 50% relative humidity compared to oxygen and <10 g/(m² d) at 23° C. and 85% relative humidity compared to water vapour.

An established process for creating a barrier in the film sector is the vacuum deposition of thin inorganic layers (aluminium, aluminium oxide, silicon oxide) using physical vapour deposition (PVD). In this process, the inorganic material is evaporated in a high vacuum, for example using an ion beam or thermal boat evaporation. The evaporated material then condenses on the substrate film and forms a closed, nanoscale (nm scale) layer. This significantly improves the basic barrier of the substrate; barrier improvement factors (BIF) of up to 10 (with reference to the substrate) are typical.

However, the PVD process places high demands on the substrate (e.g. low roughness), so that only certain plastic films such as biaxially oriented polypropylene (PP-BO), biaxially oriented polyethylene (PE-BO), biaxially oriented polyethylene terephthalate (PET-BO), rarely also polyethylene (PE) or oriented polyamide (OPA) are used.

Vacuum vapour deposition of fibre-based substrates (paper, cardboard) in particular is difficult and usually serves optical purposes rather than to create a barrier layer. Besides the roughness, the water content of paper substrates represents a major problem. This would outgas in the vacuum required in the PVD process, which makes it more difficult to build up the required vacuum and also prevents the formation of a closed barrier layer. The paper must therefore be dried before the vapour deposition process. This water must be reintroduced into the paper after the vacuum vapour deposition (in parallel with the topcoating process) (usually by wetting the back of the paper using a gravure application process). However, the width of the paper web shrinks as it dries (fibres release water), whereas it swells and becomes wider again when it is moistened again. The lacquer layer then stretches, the metallisation cracks and loses its barrier properties.

It was only through intensive investigations that special systems made of papers and barrier lacquers were found, in which the barrier properties (low hygro-expansion, low roughness, low water absorption on the coating side) of just a few types of paper were improved successfully by metallisation, with barrier lacquers under conditions that were particularly adapted to this process. This process is very limited both in terms of the selection of papers and the process conditions, and even slight deviations in the process lead to failure (extremely small process window).

For this reason, vacuum vapour deposition of paper substrates to create barrier properties is still not established industrially. Instead, in to create comparable barrier properties, the paper is typically laminated on a μm scale against an aluminium film. This is significantly more expensive and has also disadvantages in terms of sustainability.

The transfer metallisation of fibre-based substrates is another known process and is primarily used for decorative purposes, as it can produce particularly shiny surfaces for the packaging of high-quality products (spirits, perfumes, etc.).

This process is used primarily for cardboard packaging articles. Vacuum deposition can no longer be used for these articles above a certain grammage (approx. 120 g/m²), because too much water is released into the vacuum chamber and the required negative pressure cannot be built up.

During transfer metallisation, a plastic film is coated with a release varnish and then metallised by PVD. This film is laminated to the cardboard by means of an adhesive and delaminated at the point between the release varnish and the plastic film, so that the metallisation remains on the cardboard. During the process of lamination on the cardboard and delamination of the plastic film, forces become effective that lead to micro-cracks in the metal layer, so that it no longer has any barrier properties. Consequently, a barrier effect could not be achieved with this process either.

Numerous transfer metallisation processes and products thereof are described in the patent literature.

U.S. Pat. No. 4,344,998 describes a metallised composite structure and the process for its production. However, with this variant the focus is on the optical and thermal properties. A barrier function or applicability to technically challenging target substrates such as paper or biopolymers is not described here.

A transfer film according to the preamble of claim 1 is described in EP 0034392 B1. The barrier varnish used in this transfer film consists of copolymers of PVC or an acrylic copolymer.

DE 102019114198 A1 describes a metallised barrier paper, which is also obtained, among other things, through transfer metallisation. The transfer film used for this is not specified in more detail.

Various methods are described in NL 9200945 A for producing a flexible, plastic-based packaging material with barrier properties. However, a composite film component (sealing layer) is equipped with an inorganic layer. The transfer of the inorganic layer to another substrate is not mentioned in the property rights.

EP 1585668 A2 describes a metallised packaging material which is produced by transfer metallisation. However, a very specialised process is used here, in which the transfer film is first produced by extrusion, and the inorganic layer is then transferred directly to the substrate within the same production line. The properties of the release agent remain largely unmentioned. The goal of the process is to create a decorative glossy layer on a cardboard. There is no description of a barrier effect of the transferred layer.

EP 0287083 B1 also describes the decorative finishing of a cardboard laminate and improved resistance to buckling.

CA 1160552 A1 describes a composite consisting of a paper substrate, an adhesive layer, a thin metal layer and a lacquer layer, which is produced by transfer metallisation. The transfer film used in the manufacturing process is not specified in more detail.

US2017239926 AA describes a special structure of a transfer film in which the release agent consists of a polyvinyl amine cross-linked with citric acid.

U.S. Pat. No. 4,250,209 A describes a transfer film consisting of a non-pretreated polypropylene, a release agent, and a vapour-deposited metallisation. The release agent therefore primarily serves to compensate for the inadequate surface quality of the untreated carrier film in order to enable the creation of a closed surface in the subsequent metallisation step. There are no special requirements applicable to the barrier properties of the lacquer.

### Task to be Solved by the Invention

The task to be solved by the present invention is that of providing a transfer film and a method with the help of which it is possible to transfer a barrier layer to a target substrate, for example paper, with almost no loss, which forms a very good barrier, in particular against oxygen and water vapour.

### Presentation of the Invention

The task is solved with the transfer film and the method of claims 1 and 13. Advantageous variants of the transfer film are the subject of the dependent claims or may be learned from the following description and the exemplary embodiment.

The suggested composite and transfer film is formed by a carrier film with a layer sequence applied thereon, consisting of a lacquer layer made of a barrier lacquer and an inorganic layer (also referred to as metallisation) on the lacquer layer, wherein the adhesion forces between the lacquer layer and the carrier film are lower than the adhesion forces between the lacquer layer and the inorganic layer. The transfer film is characterized in that the barrier lacquer comprises a polymer matrix having a hydrophilic and a hydrophobic component, of which the hydrophobic component is in the range from 0.2-20%, better 0.5-15%, ideally 0.5%-10%, relative to the amount of substance in mol. The hydrophilic component is at least 70 mol %. For thermoplastic lacquer systems, this molar ratio is determined using thermal analysis (melting point determination including referencing with monomers; differential scanning calorimetry (DSC); heating programme: 23-300° C., 10° C./min heating rate) in accordance with DIN EN ISO 11357-1. For protein-based lacquers, the ratio is determined on the basis of the chemical structure (taken from protein databases such as SCOPe) or from the results of GC-MS measurements. Polyester-based lacquer systems can be analysed using thermal analysis or by means of GC-MS investigations.

To produce the transfer film, a plastic-based carrier film is coated with a barrier lacquer, based on polyvinyl alcohol (PVOH), modified polyvinyl alcohol or ethylene-vinyl alcohol (EVOH) for example, by extrusion or wet chemical process, for example, and dried appropriately. The carrier film may be made for example of biaxially oriented (PP-BO), biaxially oriented polyethylene (BO-PE), biaxially oriented polyethylene terephthalate (PET-BO), polypropylene (PP), polyethylene (PE), polyethylene terephthalate (PET), axially or biaxially oriented polyamide (OPA), polyamide (PA) or of another polymer film of sufficient surface quality. The essential feature of the lacquer properties in this context is that the lacquer matrix has both hydrophilic and a small degree of hydrophobic properties. This may be achieved through the chemical property of the lacquer (as a copolymer, blend, or the like).

The barrier lacquer is characterized in that it consists predominantly (at least 70 mol %, preferably at least 80 mol %) of hydrophilic components, preferably hydrophilic monomers (e.g. vinyl alcohol). Hydrophilic monomers in a copolymer have barrier properties with respect to non-polar substances such as oxygen. When selecting the barrier lacquer, it is also essential to have a certain proportion of hydrophobic functional groups (e.g. ethylene) in the copolymer. These have a barrier effect to polar substances (such as water vapour) due to their low solubility.

In an advantageous variant of the transfer film, a barrier lacquer is used which consists of a copolymer that is predominantly composed of hydrophilic monomers (at least 70 mol %, preferably at least 80 mol %). This means that the lacquer has intrinsic oxygen barrier properties. The smaller proportion (max. 20 mol %) consists of hydrophobic monomers, which, despite their chemical structure, do not lend the lacquer any intrinsic water vapour barrier properties. The lacquer to be chosen thus has an oxygen barrier but not a water vapour barrier. Moreover, the barrier lacquer is characterized in that its adhesion forces to the inorganic layer are greater than those to the carrier film.

This coated side of the carrier film is then coated with an inorganic layer, made of aluminium, aluminium oxide, or silicon oxide, for example, using a suitable process.

Surprisingly, it has been found that the combination of barrier lacquer layer and inorganic layer results in synergistic effects with regard to the barrier properties that exceed the sum of the barrier properties of the individual layers. The structure of organic barrier lacquer and inorganic coating, in particular vapour deposition, means that, unlike the film and lacquer structure, the small proportion of hydrophobic components in the lacquer is effective, and the structure of film, lacquer and inorganic layer has particularly outstanding barrier properties in respect of both oxygen and water vapour.

In order to transfer the barrier layer, consisting of the layer sequence of lacquer layer and inorganic layer, to a target substrate, the inorganically coated side of the transfer film is first coated with an adhesive (e.g. polyurethane or hot melt adhesive) on and laminated on the target substrate (e.g. made of paper, cartons, biopolymers etc.) so that the following structure results:
Carrier film/Barrier lacquer layer/Inorganic layer/Adhesive/Target substrate.

The process is particularly advantageous in terms of the barrier properties of the target substrate provided with the barrier layer if it is not the transfer film that is coated with adhesive during the laminating process, but the target substrate. The reason for this is that the barrier layer (lacquer layer+inorganic layer) at this point is still relatively highly sensitive to mechanical stress and contact with solvent-containing or water-based adhesives.

In a further step, typically when cutting or wrapping the film/paper composite (for a target substrate made of paper), the carrier film is separated from the lacquer layer consists of barrier lacquer due to the existing low adhesion forces and wrapped separately. This leaves the following structure as the end product (shown in reverse order):
Target substrate/Adhesive/Inorganic layer/Barrier lacquer layer

Surprisingly, it has been found that with the structure of the transfer film as described, a non-destructive transfer of the barrier lacquer layer and the inorganic layer to the target substrate is possible without the use of an additional debonding agent. This means that the desired barrier values on target substrates for the food industry in respect of oxygen (</=1 cm³/(m² d bar) at 23° C. and 50% and water vapour (</=1 g³/(m² d) at 23° C. and 85% RH) can also be transferred to target substrates that do not normally have sufficient barrier properties (e.g., paper, cartons, biopolymers, etc.).

### BRIEF DESCRIPTION OF THE DRAWINGS

The suggested transfer film and the suggested method are described again in greater detail in the following text with reference to examples in conjunction with the drawings. In the drawings:

FIG. 1 shows an exemplary structure of the transfer film;

FIG. 2 shows a composite structure between the target substrate and transfer film after application of the transfer film, and

FIG. 3 shows the finished composite after removal of the carrier film.

### WAYS OF IMPLEMENTING THE INVENTION

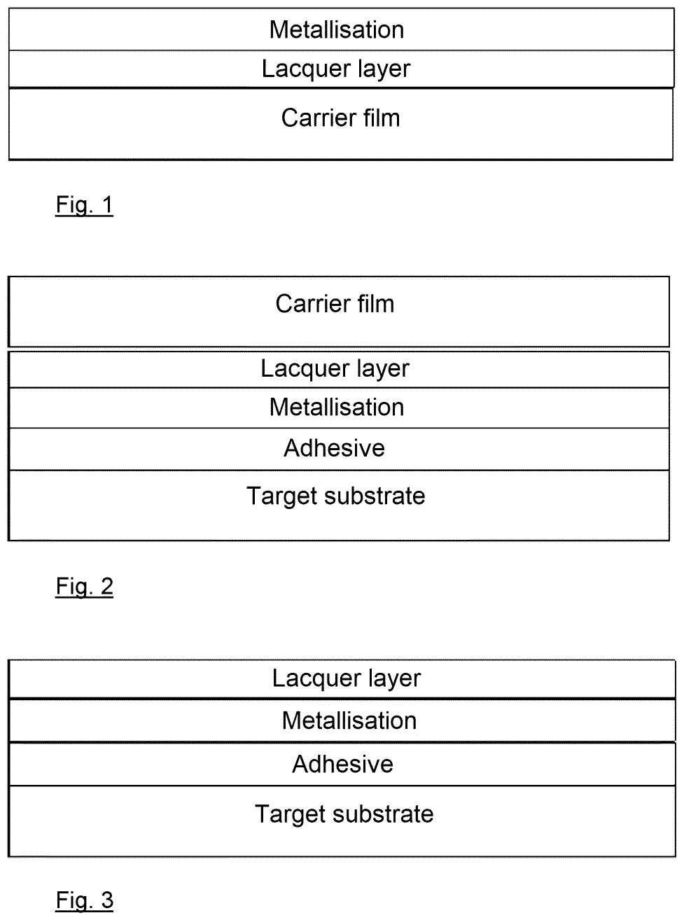

The present invention describes a transfer film consisting of a carrier film (e.g. PET), a lacquer layer (e.g. EVOH) and an inorganic layer (e.g. of aluminium, aluminium oxide, silicon oxide, etc.) applied by physical vapour deposition (PVD) or comparable processes (e.g. atomic layer deposition (ALD), chemical vapour deposition (CVD)), as shown schematically in FIG. 1.

The barrier lacquer is preferably applied to the carrier film by extrusion coating or wet chemical processes. Suitable wet chemical processes include application using a doctor blade, flexography, roller coating, spray coating; dip coating, slotted nozzle, and curtain coating.

Examples of suitable carrier films are biaxially oriented (PP-BO), biaxially oriented polyethylene (BO-PE), biaxially oriented polyethylene terephthalate (PET-BO), polypropylene (PP), polyethylene (PE), polyethylene terephthalate (PET), axially or biaxially oriented polyamide (OPA), polyamide (PA) or another polymer film.

In the case of a wet chemical coating, the coating process is followed by a drying step to remove the solvent. Drying may be carried out, for example, by convection, microwave, vacuum, infrared drying or combinations thereof.

The formulation used for the coating is based on one or more solvents such as a monohydric alcohol (ethanol, propanol, butanol, etc.), water, an ester (e.g. ethyl acetate) or combinations thereof and a lacquer component.

The paint component used is characterized in that it forms a closed layer after application to the carrier film and drying if necessary. This layer has a good oxygen barrier but only a weak water vapour barrier.

The oxygen permeability (measured according to DIN 53380-3 at 23° C. and a relative humidity of 50%) of the lacquer layer (standardised to a layer thickness of 100 μm) is typically below 5 cm³/(m² d bar), better below 2.5 cm³/(m² d bar), better still below 0.5 cm³/(m² d bar), ideally below 0.05 cm³/(m² d bar).

The water vapour permeability (measured according to DIN EN ISO 15106-3 at 23° C. and a relative humidity of 85%) of the lacquer layer (standardised to a layer thickness of 100 μm) is typically below 100 g/(m² d), better below 50 g/(m² d), ideally below 20 g/(m² d), but still above 10 g/(m² d) in each case.

The layer thickness of the dried lacquer layer is usually between 5 nm and 100 μm, better between 7 nm and 50 μm, even better between 10 nm and 30 μm, ideally between 10 nm and 10 μm. The lacquer layer thickness is determined either with the help of a mechanical sensor (as a differential measurement between uncoated and coated carrier film), as a microscopic representation of a cross section made with a microtome, or as a differential weighing of a grammage determination of the coated and uncoated carrier film.

Particularly suitable lacquer components are components that are soluble or dispersible in the selected solvent and have the barrier properties described after application to the carrier film. The chemical polymer matrix is fundamental here. In order to achieve the desired barrier properties on the target substrate, the polymer matrix has both a hydrophilic and a significantly lower hydrophobic proportion.

Examples of polymers with hydrophilic/hydrophobic properties for this include hydrophobically modified PVOH, EVOH, modified EVOH, medium chain length polyhydroxyalkanoates (mPHA), oligomeric lactic acid (oLA), cutin and its derivatives, and combinations thereof.

The hydrophobic fraction in the polymer matrix is preferably between 0.5 and 20 mol %, better between 2 and 10 mol %, and ideally between 3 and 8 mol %.

Due to this relatively low fraction of hydrophobic components in the polymer matrix, the barrier lacquer does have a significant barrier to oxygen when used on a film substrate, but it does not offer a barrier to water vapour that is sufficient for applications in the packaging sector. Typically, the barrier lacquer then has a water vapour permeability of over 10 g/(m² d) at 23° C. and 85% relative humidity. Surprisingly, however, it has been found that after the application of a nanoscale inorganic layer described below (e.g. by vacuum vapour deposition), synergistic effects occur between the lacquer, in particular the hydrophobic lacquer component, and the inorganic coating material. As a result, water vapour permeabilities </=1 g/(m² d) at 23° C. and 85% RH are achieved on the transfer film, which can then be transferred to the target substrate. The water vapour permeability values are standardised for a layer thickness of 100 μm in each case.

The proportion of the lacquer component in the coating formulation for applying the lacquer layer in extrusion coating is ideally more than 70% (m/m), better more than 80% (m/m), and ideally over 90% (m/m).

In the formulation for a wet chemical coating, the proportion of the lacquer component is usually between 0.1 and 60% (m/m), better between 0.5 and 40% (m/m), and ideally between 1 and 20% (m/m).

In a next step, one or more inorganic layer(s), preferably consisting of aluminium (Al), aluminium oxide (AlOx), silicon (Si), silicon oxide (SiOx) or combinations thereof, is/are applied to the barrier lacquer layer. The inorganic layer is applied by Physical Vapour Deposition (PVD), Chemical Vapour Deposition (CVD), Plasma-Enhanced Chemical Vapour Deposition (PECVD), Atomic Layer Deposition (ALD), wet chemical deposition of nanoparticles (such as sheet silicates) or other processes that are suitable for depositing nanoscale, inorganic layers on plastic substrates.

The layer thickness (determined with scanning electron microscopy) of the inorganic coating is usually between 3 nm and 990 nm, better between 4 nm and 750 nm, ideally between 5 nm and 500 nm.

By applying this inorganic layer (measured according to DIN 53380-3 at 23° C. and a relative humidity of 50%), oxygen permeability is typically reduced by a factor of 2, better by a factor of 5, ideally by a factor of 10 or more compared to the pure lacquer layer.

By applying the inorganic layer, water vapour permeability (measured according to DIN EN ISO 15106-3 at 23° C. and a relative humidity of 85%), is typically reduced by a factor of 2-20, better by a factor of 20-50, ideally by a factor of 50-500.

In a particularly advantageous variant of the invention, the inorganic layer is furnished with a further coating of the barrier lacquer.

The primary task of the transfer film according to the invention is to transfer the combination of barrier lacquer layer and inorganic coating from the carrier film to a target substrate. Target substrates are usually flat materials that cannot easily be provided with inorganic, nanoscale barrier layers. Examples of such are papers, cardboard articles, biopolymers (cellophane, polylactic acid, polyhydroxyalkanoates, polybutyl succinates, etc.), (natural) fibre-plastic composites, textiles, and nonwovens as well as conventional plastics with surface properties that do not lend themselves to coating by the methods described above, such as PVD.

Now, in order to transfer the inorganic layer, hereinafter referred to as metallisation, and the lacquer layer, a laminating adhesive (e.g., polyurethane-based) is applied to the target substrate or the inorganic layer.

This laminating adhesive is characterized in that its adhesion to the metallisation after drying is greater than the strength of the bond between the lacquer layer and the carrier film. The adhesion between laminating adhesive and metallisation is typically stronger than the adhesion between the barrier lacquer layer and the carrier film by a factor of 2, better a factor of 5, ideally by a factor of at least 10.

The transfer film is then bonded on the metallised side to the target substrate, as shown schematically in FIG. 2.

In order to ensure a successful transfer of the lacquer layer and metallisation from the carrier to the target substrate, besides the abovementioned properties the barrier lacquer is further characterized in that the adhesion between the barrier lacquer layer and the metallisation is stronger than the adhesion between the barrier lacquer layer and the carrier film. Typically, the adhesion between the barrier lacquer layer and the metallisation is stronger than the adhesive bond between the barrier lacquer layer and the carrier film by a factor of 2, better a factor of 5, ideally a factor of at least 10.

Subsequently, in a final step, for example when wrapping the film, the carrier film is removed, wherein both the lacquer layer and the metallisation are left on the target substrate (see FIG. 3). Surprisingly, it has been found that a transfer of the metallisation and the barrier lacquer layer to the target substrate is possible without significant damage to the nanoscale metallisation even without the use of detachment promoting additives, also called “release agents” (e.g., butyl acetate, waxes, paraffins, silicones).

Surprisingly, it was found that the barrier properties of the metallisation and lacquer layer created on the carrier film are retained in the final composite to a very large extent and were thus transferred to the target substrate in the transfer process. This means that substrates can now also be equipped with barrier properties for which this was previously not technically possible or financially practical.

Oxygen permeability (measured according to DIN 53380-3 at 23° C. and a relative humidity of 50%) of the composite after transfer of the metallisation and the barrier lacquer layer to the target substrate and after removal of the carrier film is typically less than 10 cm³/(m² d bar), better less than 5 cm³/(m² d bar), better still less than 5 cm³/(m² d bar), ideally less than 2 cm³/(m² d bar), standardised to a layer thickness of 100 μm in each case.

The water vapour permeability (measured according to DIN EN ISO 15106-3 at 23° C. and a relative humidity of 85%) of the composite after the transfer of the metallisation and the barrier lacquer layer to the target substrate and after removal of the carrier film is typically less than 10 g/(m² d), better less than 2 g/(m² d), ideally less than 1 g/(m² d), standardised to a layer thickness of 100 μm in each case.

The use of the transfer film according to the invention thus allows the transfer of a barrier lacquer layer and a nanoscale metallisation to a target substrate without any significant loss of the oxygen and water vapour barrier. This enables, for example, substrates that themselves have no or no significant barrier properties to be used as primary packaging for sensitive and highly sensitive foods.

A further advantage of the transferred combination of metallisation and barrier lacquer layer is that the metallisation in particular functions as a barrier layer to substances that are undesirable yet occur particularly in plastic and paper recyclates (mineral oil, additives, non-intentionally added substances (NIAS)). The use of the transfer film thus allows the transfer of the barrier layer consisting of metallisation and barrier lacquer layer to target substrates that contain recycled materials, and their use, for example, in (food) packaging. Furthermore, this approach may be supplemented with additional layers (e.g., ethylene-vinyl acetate lacquers or ethylene-acrylic acid lacquers), so that thermal bondability of the target substrate is achieved with heat sealing. In this way, barrier properties and a possible option for assembly into shaped bodies may be provided for the target substrate using a simple lamination process.

### Application Example: Transfer to Fibre-Based Substrate

In the decorative finishing sector, finishing films for transfer metallisation are widely available on the commercial market. These types of finishing film are used to refine printed texts and line drawings, for example. In this way, it is possible to achieve similar effects to glossy embossing, for example. However, the focus in these applications is on the visual appearance. A freely available finishing film from Bergmann Handels OHG (“Creativ-Papier” glossy silver finishing film) has no barrier properties whatsoever, as is shown in Table 1:

TABLE 1
Barrier properties of a standard commercial finishing film

| | Test | | |
|---|---|---|---|
| Property | standard | Test conditions | Value |
| Oxygen | DIN 53380- | 23° C., | 424 cm³/(m² |
| permeability | 3 | 50% RH | d bar) |
| Water vapour | DIN 53122- | 23° C., | 5.5 g/(m² |
| permeability | 1 | 85% RH | d) |

The following text describes how a fibre-based substrate was provided with excellent barrier properties through use of the suggested method.

A 50 μm, biaxially oriented PET film (type Mitsubishi Hostaphan RNK 75) was coated with a polyvinyl alcohol-based lacquer in a roll-to-roll process. Surface pre-treatment of the film, as is common in film finishing processes, was deliberately omitted. The lacquer is a water-based, modified PVOH system (Kuraray Exceval AQ 4104) with an ethylene content of 8 mol %. In this case, this 8% corresponds to the hydrophobic component. The PVOH solution was adjusted to a solids content of 15% (w/w). The PET in web form was dried using a convective web dryer at a drying temperature of 95° C. A dry layer grammage of ˜2 g/m² was achieved.

The lacquered PET substrate was then vapour-coated with aluminium on the PVOH side. The vapour deposition was applied using a PVD process under vacuum. The vacuum strength was between 10⁻⁵ and 10⁻³ mbar. In this case, the evaporation of the aluminium was carried out using an electron beam source. The layer thickness of the aluminium vapour deposition was monitored using a quartz oscillator and was between 50-100 nm. After opening the chamber, the film was reconditioned at 23° C. and 50% RH for 1 day. Reconditioning represents the final step in the production of the transfer film. This yields a final structure as described in conjunction with FIG. 1.

The transfer film is characterized by excellent barrier properties, which are summarized in Table 2.

TABLE 2
Permeation properties of the transfer film, testing
carried out by a DAAkS-accredited testing laboratory

| | Test | Test | |
|---|---|---|---|
| Property | standard | conditions | Value |
| Oxygen | DIN 53380- | 23° C., | <0.05 cm³/(m² |
| permeability | 3 | 50% RH | d bar) |
| Water vapour | DIN EN ISO | 23° C., | <0.05 g/(m² |
| permeability | 15106-3 | 85% RH | d) |

In order to equip a fibre-based material with barrier properties, in a first step the fibre-based material (Pack Pro 7.0 packaging paper from Brigl & Bergmeister) was coated on the uncoated side with a two-component polyurethane adhesive solution. The ethyl acetate-based solution had a solids content of 65%. Drying was carried out using a convection web dryer at a drying temperature of 50° C. In the laminating unit, the adhesive-coated side of the packaging paper was then laminated against the metallised side of the transfer film and wound up.

At this point, the dry layer thickness of the adhesive was in a dry layer range between 3 g/m² and 5 g/m². The overall structure at this stage corresponds to that in FIG. 2.

The entire composite was then separated using a rewinding station. Due to the low adhesion forces between the PET film and the PVOH layer, the composite separates most readily at this point. Using this principle, the PVOH+metallisation barrier system was transferred from the transfer film to the target substrate. The result was a composite structure according to FIG. 3, with the permeation values shown in Table 3.

TABLE 3
Permeation properties of the finished paper, testing
carried out by a DAAkS-accredited testing laboratory

| | Test | Test | |
|---|---|---|---|
| Property | standard | conditions | Value |
| Oxygen | DIN 53380- | 23° C., | 1.0 cm³/(m² d |
| permeability | 3 | 50% RH | bar) |
| Water vapour | DIN EN ISO | 23° C., | 0.05 g/(m² |
| permeability | 15106-3 | 85% RH | d) |

1. Composite film for transferring a barrier layer to another substrate, which comprises a carrier film on which a layer sequence is applied consisting of at least one lacquer layer made of a barrier lacquer and an inorganic layer on the lacquer layer, wherein adhesion forces between lacquer layer and carrier film are lower than adhesion forces between lacquer layer and inorganic layer,
characterized in that
the barrier lacquer has a polymer matrix with a hydrophilic and a hydrophobic component, of which the hydrophobic portion is between 0.2-20% and the hydrophilic portion is at least 70%, relative to the amount of substance in mol in each case.

2. Composite film according to claim 1,
characterized in that
the hydrophobic portion in the polymer matrix of the barrier lacquer is between 0.5 and 15 mol %, preferably between 0.5 and 10 mol %.

3. Composite film according to claim 1,
characterized in that
the hydrophilic portion in the polymer matrix of the barrier lacquer is selected such that an oxygen permeability of the lacquer layer, measured according to DIN 53380-3 at 23° C. and a relative humidity of 50%, standardised to a layer thickness of 100 μm, is less than 5 cm³/(m² d bar).

4. Composite film according to claim 3,
characterized in that
the hydrophilic portion in the polymer matrix is selected such that the oxygen permeability of the lacquer layer, measured according to DIN 53380-3 at 23° C. and a relative humidity of 50%, standardised to a layer thickness of 100 μm, is less than 2.5 cm³/(m² d bar), preferably less than 0.5 cm³/(m² d bar), particularly preferably less than 0.05 cm³/(m² d bar).

5. Composite film according to claim 1,
characterized in that
the hydrophobic portion in the polymer matrix is selected such that a water vapour permeability of the lacquer layer, measured according to DIN EN ISO 15106-3 at 23° C. and a relative humidity of 85%, standardised to a layer thickness of 100 μm, is still over 10 g/(m² d) and under 100 g/(m² d).

6. Composite film according to claim 5,
characterized in that
the hydrophobic portion in the polymer matrix is selected such that the water vapour permeability of the lacquer layer, measured according to DIN EN ISO 15106-3 at 23° C. and relative humidity of 85%, standardised to a layer thickness of 100 μm, is still over 10 g/(m² d) and under 50 g/(m² d), preferably still over 10 g/(m² d) and under 20 g/(m² d).

7. Composite film according to claim 1,
characterized in that
the lacquer layer has a layer thickness between 5 nm and 100 μm, preferably between 7 nm and 50 μm.

8. Composite film according to claim 1,
characterized in that
the lacquer layer has a layer thickness between 10 nm and 30 μm, preferably between 10 nm and 10 μm.

9. Composite film according to claim 1,
characterized in that
the inorganic layer has a layer thickness between 3 nm and 990 nm, preferably between 4 nm and 750 nm, particularly preferably between 5 nm and 500 nm.

10. Composite film according to claim 1,
characterized in that
the barrier lacquer is formed from hydrophobically modified PVOH, EVOH, modified EVOH, medium chain length polyhydroxyalkanoates (mPHA), oligomeric lactic acid (oLA), cutin or its derivatives, or a combination of several of these substances.

11. Composite film according to claim 1,
characterized in that
the inorganic layer consists of aluminium (Al), aluminium oxide (AlOx), silicon (Si), silicon oxide (SiOx) or a combination of several of these substances.

12. Composite film according to claim 1,
characterized in that
the layer sequence of the lacquer layer and the inorganic layer on the composite film has a water vapour permeability, measured according to DIN EN ISO 15106-3 at 23° C. and a relative humidity of 85%, standardised to a layer thickness of 100 μm, from </=1 g/(m² d).

13. Method for transferring a barrier layer to another substrate, in which
a composite film according to claim 1 is provided,
the composite film is connected to a surface of the substrate on the side of the inorganic layer via an adhesive layer, wherein the adhesive for the adhesive layer is selected such that an adhesion of the inorganic layer to the surface of the substrate is stronger than between the lacquer layer and the carrier film, and
the carrier film is then removed so that the layer sequence consisting of the lacquer layer and the inorganic layer remains on the substrate as a barrier layer.

14. Method according to claim 13,
characterized in that
the adhesive layer is applied to the surface of the substrate before connecting the composite film to the surface of the substrate.
